(19) United States
(12) Patent Application Publication
(10) Pub. No.: US 2004/0062705 A1
(43) Pub. Date: Apr. 1, 2004

(54) Process for lowering the content of organic matter and nitrogenous products contained in bromide-containing effluents

(76) Inventor: Philippe Leduc, Saint Sorlin (FR)

Correspondence Address: Thomas F. Roland, Esq., ATOFINA Chemicals, Inc., Patent Department-26th Floor, 2000 Market Street, Philadelphia, PA, 19103-3222, US

(21) Appl. No.: 10/671,976

(22) Filed: Sep. 26, 2003

(30) Foreign Application Priority Data
Sep. 26, 2002 (FR) FR02.11927

(51) Int. Cl. C01B 7/00

(52) U.S. Cl. 423/462

(57) ABSTRACT

The invention relates to a process for lowering the content of organic matter and of nitrogenous products contained in a liquid to solid bromine-containing effluent, which consists in subjecting the said effluent to one or more physicochemical treatments chosen from:

a) acidification of an aqueous bromide-containing solution or of a solution obtained by dissolution if the bromide-containing effluent is solid, followed by vapour entrainment of the light organic compounds;

b) basification of the solution obtained in a) or of initial aqueous bromide-containing solution obtained by dissolution if the bromide-containing effluent is solid, followed by vapour entrainment of the light organoamine compounds and/or of NH₃;

c) vapour entrainment of light organic compounds from the aqueous solution obtained in a), or from the solution obtained in b), or from an initial bromide-containing solution obtained by dissolution if the effluent is solid, without modifying the pH;

d) washing a solid bromide-containing effluent to be treated or a solid derived from the evaporation of an aqueous bromide-containing solution resulting from one or more preceding treatment(s), with an organic solvent, filtration of the suspension obtained, and washing and drying of the cake obtained.

### FIELD OF THE INVENTION

The present invention relates to a process for lowering the content of organic matter and of nitrogenous products contained in bromide-containing effluents in order to upgrade them, especially to elemental bromine.

### BACKGROUND OF THE INVENTION

Organobromine compounds are commonly used as intermediates in the manufacture of other organic molecules.

For example, the pharmaceutical industry uses many organobromine compounds (alkyl bromides, bromo acids and bromo esters) as synthetic intermediates especially for grafting the organic part of the organobromine compound onto another molecule. Thus, an organobromine compound RBr can react with a nucleophile Nu, which displaces the bromine to give an organic compound substituted with the nucleophile plus a bromide Br⁻ as by-product, according to the reaction scheme:

RBr+M⁺Nu⁻→RNu+M⁺Br⁻

in which Nu⁻ is a nucleophilic anion,

M⁺ is either an alkali metal (Li, Na or K) or NH₄⁺ or a hydrogen ion.

The bromine in fact serves merely as a transfer agent and is generally found in the form of alkaline bromides in the plant effluents.

Users of organobromine compounds are thus confronted with a problem of discarding the effluents, linked both to the very nature of the effluents, which are generally aqueous bromide-containing solutions containing alkaline bromides, ammonium bromides or even HBr, and also to the pollutant organic compounds they contain.

The content of organic compounds in the bromide-containing effluents is expressed as Total Organic Carbon or TOC. These organic compounds may be acids, amines, alcohols, solvents or ammonium salts. An excessively high content of this organic matter in bromide-containing effluents is prohibitive when it is desired to recover the bromides contained in the effluents in the form of elemental bromine via conventional methods such as the chlorine oxidation method according to a process known as “steaming-out” developed by K. Kubierschky, (“Bromine and its compounds”, edited by Z. Z. Jolles; Ernest Benn Limited, pages 20 to 24, London 1966).

This method consists in placing an aqueous bromide-containing solution in contact with chlorine gas.

This reaction is generally performed in a packed tower (bromine tower) in which an aqueous bromide-containing solution is placed in contact with chlorine and water vapour. The chlorine reacts with the bromide ion Br⁻ to produce elemental bromine Br₂ and a chloride ion according to the reaction:

2Br⁻+Cl₂→Br₂+2Cl⁻

A mixture of bromine, chlorine and water vapour exits at the top of the tower and is cooled to condense the bromine.

However, if the aqueous bromide-containing solution used contains organic matter, there is a risk of this matter polluting the bromine released.

In addition, the presence of oxidizable organic matter and/or of nitrogenous organic matter can entail risks of explosiveness (formation especially of NBr₃, which is explosive).

Finally, an excessively high content of organic matter in the bromide-containing solutions has the risk of leading to the formation of solid products that may cause blockaging in the plant.

There is consequently a need to minimize the content of organic matter and of nitrogenous compounds in the bromide-containing effluents to be upgraded.

Other solutions have been proposed for regenerating elemental bromine from aqueous bromide-containing solutions containing organic matter.

Thus, patent U.S. Pat. No. 5,385,650 proposes a process that consists in electrolysing acidic aqueous bromide-containing solutions containing organic matter (TOC which may be up to 3 650 ppm).

To do this, a two-compartment electrolysis cell is fed with an acidic aqueous bromide-containing solution, working at a temperature of not more than 95° C., with a current density of between 1 and 4 kAm⁻².

The bromine, released at the anode, is recovered in the form of vapour from the analyte under reduced pressure.

There are many drawbacks with working in this way.

Given the high solubility of bromine in aqueous bromide-containing solutions, it is difficult to recover all of the bromine formed.

In addition, the oxidation of the organic matter at the anode consumes large amounts of current. Thus, for example, in Example 1 of U.S. Pat. No. 5,385,650, it is found that the presence of organic matter (2 250 ppm of TOC) in the aqueous bromide-containing solution to be treated causes the efficacy of the current for generating the bromine to fall by 9% for a 23% reduction in the TOC.

The presence of oxidizable and thus energy-consuming, non-volatile organic matter capable of interacting with the bromine also makes it necessary to perform purges in order to remove this matter from the anode compartment.

Another solution consists in separating the bromides from the organic matter by electrodialysis, but the membranes have a limited performance in the presence of organic compounds and there is a large risk of blocking and/or clogging.

The organic impurities may also be oxidized to CO₂ and H₂O by means of H₂O₂.

However, the yields are low and, in addition, the hydrogen peroxide decomposes in the presence of bromine according to the reaction:

Br₂+H₂O₂→O₂+2Br⁻+2H⁺⁻

In U.S. Pat. No. 4,029,732, it has been proposed to circumvent this drawback by using a device for separating out the bromine released, gradually as it is formed. This way of operating was applied most particularly to the treatment of “bromosulphuric” hydrobromic solutions, containing little or no organic compounds which would proportionately reduce the oxidation yield.

A process has now been found for lowering, or even eliminating, the organic matter content of bromide-containing effluents in order to upgrade the bromides contained in the said effluents to elemental bromine; the said effluents, if solid, being able to be dissolved in water.

### SUMMARY OF THE INVENTION

One subject of the invention is thus a process for lowering the content of organic matter and of nitrogenous products contained in a bromide-containing effluent that is in the form of an aqueous bromide-containing solution or of a bromide-containing solid, in order especially to upgrade the bromides contained in the said effluent to elemental bromine, the said process being characterized in that the bromide-containing effluent is subjected to one or more physicochemical treatments chosen from:

a) acidification of an aqueous bromide-containing solution or of a solution obtained by dissolution if the bromide-containing effluent is solid, followed by vapour entrainment of the light organic compounds;

b) basification of the solution obtained in a) or of the initial aqueous bromide-containing solution obtained by dissolution if the bromide-containing effluent is solid, followed by vapour entrainment of the light organoamine compounds and/or of NH₃;

c) vapour entrainment of light organic compounds from the aqueous solution obtained in a), or from the solution obtained in b), or from an initial bromide-containing solution obtained by dissolution if the effluent is solid, without modifying the pH;

d) washing a solid bromide-containing effluent to be treated or a solid derived from the evaporation of an aqueous bromide-containing solution (optionally) resulting from one (or more) preceding treatment(s) a), b) and/or c), with an organic solvent that dissolves the minimum amount of alkaline bromides and the maximum amount of organic compounds, and filtration of the suspension obtained. The cake, washed and dried, is redissolved in water.

### DETAILED DESCRIPTION OF THE INVENTION

As organic solvents that may be used according to the present invention, mention will be made of acetonitrile, sec-butanol, isopropanol, acetone, etc.

Isopropanol will preferably be used.

The aqueous bromide-containing solution thus obtained, freed of virtually all of its organic matter, preferably having a TOC of not more than 2 000 mg/l and a nitrogen content of not more than 50 mg/l, may be subjected to a known process for the upgrading of bromides to elemental bromine. The chlorine oxidation process as described above will preferably be used.

The bromide-containing effluent treated according to the invention may also be upgraded in the fields of photography, engraving, lithography and therapeutics.

According to the present invention, the TOC and the total nitrogen content of the bromide-containing effluent to be upgraded is determined in a first stage.

The TOC was determined according to a method by combustion of a sample and infra-red analysis of the resulting CO₂ (NDIR, non-dispersive infrared gas analyser). The results are expressed in mg/l of TOC relative to an aqueous solution containing 300 g/l bromides.

The total nitrogen is determined by mineralization of a sample of the bromide-containing effluent and the back-titration of NH₃ formed according to the general method known as the Kjeldahl method. The results are expressed in mg/l of nitrogen relative to an aqueous solution containing 300 g/l of bromides.

Next, it falls to a person skilled in the art having knowledge of the region of the aqueous bromide-containing solution to be upgraded, and thus qualitative knowledge of the organic compounds present, to apply in a logical order and as economically as possible the various treatments of the process of the present invention in order to minimize the TOC and the total nitrogen content of the said effluent.

Thus, according to the present invention, and in the most general case, the bromide-containing effluent may be subjected to one or more treatments a), b), c) or d) mentioned above in the order a), b), c), d), or in any order depending on the nature of the organic matter and nitrogenous products present to be removed and on the form of the bromide-containing effluent to be treated.

Thus, for example, in the event that the bromide-containing effluent contains only light organic acid compounds, it will be subjected to treatment a) only.

In the event that it also contains light nitrogenous compounds and/or aqueous ammonia, the solution obtained in a) will be subjected to treatment b).

According to the present invention, the process applies both to aqueous bromide-containing solutions and to bromide-containing solids.

Specifically, if the effluent is bound to be in solid form, it may be subjected directly to treatment d) (washing with solvent) or dissolved in water before being treated according to a), b) and/or c) of the process of the invention.

Thus, according to the present invention, if the bromide-containing effluent is solid, it can be made to dissolve by adding water, at room temperature, so as to obtain an aqueous solution containing from 100 to 500 g/l of bromides, and preferably containing an amount of bromides in the region of 300 g/l.

According to the present invention, the acidification of the bromide-containing solution—treatment a)—may be performed with a sufficient amount of a mineral acid such as H₂SO₄, HCl, H₃PO₄ or HBr so as to obtain a pH of not more than 3. Advantageously, “residual” HBr will be used (obtained as by-product during the synthesis of a bromo derivative, for example).

The basification—treatment b)—of the bromide-containing solution may be performed with an alkaline agent such as NaOH or KOH used in an amount that is sufficient to obtain a pH of at least 10.

According to the present invention, the vapour entrainment is performed by injecting water or water vapour into the acidic, basic or neutral bromide-containing solution maintained at a temperature of at least 100° C., at atmospheric pressure.

The evaporation of the bromide-containing solution to obtain a solid (which will be treated according to d)) may be performed by distillation under reduced pressure at temperatures of between 20° C. and 100° C.

The filtration of the concentrate may be performed continuously during the evaporation treatment using a suitable filtration system.

The washing of the solid bromide cake with organic solvent may be performed directly on the filter or on the crumbled cake suspended in the solvent with stirring.

The drying of the cake may be performed by the passage of air or another gas heated to a temperature of at least 30° C.

The solvents from the solid bromide washes may be recycled after purification by distillation or any other suitable process.

The process of the present invention allows the treatment of any solid or liquid bromide-containing effluent that may contain high contents of organic matter and/or also high contents of nitrogenous products and has the advantage of producing an aqueous bromide-containing solution with an alkaline bromide concentration of between 100 g/l and 500 g/l and preferably in the region of 300 g/l, and containing not more than 2 000 mg/l of TOC and not more than 50 mg/l of total nitrogen. This solution may be upgraded directly to elemental bromine using an existing chlorine oxidation plant (bromine tower).

The examples that follow illustrate the invention.

The TOC and total nitrogen content were determined as described previously. The TOC was performed on a “Shimadzu TOC Control” machine reference 5050 A.

The practice of the invention is illustrated in more detail in the following on-limiting examples.

### EXAMPLES

### Example 1

Treatment of a basic aqueous bromide-containing solution containing aqueous ammonia:

A solution of NaBr derived from the manufacture of a pharmaceutical intermediate, having the following mean composition:

Bromide content: about 300 g/l,

pH=13,

NH₃: 15 to 16 g/l,

Total nitrogen: from 12 to 13 g/l,

TOC: 17 to 18 g/l derived essentially from the presence in the said solution of ethanol: ˜0.1%, of ethoxyethanol: 2 to 3%, of valeric acid: 0.3 to 0.4%, of valeronitrile and of toluene.

100 kg of this basic aqueous bromide-containing solution are subjected directly to entrainment with water vapour. 50 to 60 kg of ammonia gas (NH₃) are recovered at the top of the condenser, and are neutralized with H₂SO₄ solution.

The condensates obtained, with TOC of 22 g/l, consist essentially of ethoxyethanol, valeronitrile and toluene in aqueous solution.

The reactor residue containing the treated solution has a TOC of 1.85 g/l and a nitrogen content equal to 6 mg/l.

This solution can thus already be oxidized to obtain bromine without any particular risk of formation of explosive products, such as NBr₃.

This example illustrates the invention by the fact that treatment c) has been applied to an aqueous bromide-containing solution in order to upgrade it to elemental bromine.

The upgrading to elemental bromine from the aqueous bromide-containing solution treated according to the present invention may be performed by oxidation using chlorine as described above.

However, in order to further reduce the TOC, a further treatment is applied to the solution treated above.

The solution treated above still contains 1.85 g/l of TOC, corresponding essentially to the sodium salt of valeric acid.

This solution of pH 13 is acidified with H₂SO₄ until a pH of 3 is obtained.

This solution thus acidified is subjected to entrainment with water vapour, allowing the valeric acid freed at the time of the acidification to be collected in the distillate.

The aqueous bromide-containing (NaBr) solution thus treated has a TOC of 0.5 g/l and is entirely acceptable for direct upgrading to elemental bromine via the chlorine oxidation process.

This example clearly illustrates the invention by the fact that two treatments have been applied: c) and a) to a basic aqueous bromide-containing solution in order to upgrade it to elemental bromine.

In addition, due to the fact that the initial solution to be treated is basic, a person skilled in the art has logically applied step c) first, followed by step a), which clearly demonstrates that it falls to a person skilled in the art who has knowledge of the origin of the aqueous bromide-containing solution and thus of its composition, to apply the various treatments of the process in the order that makes it possible to achieve the best reduction, in an economic manner, of the TOC and to remove virtually all the nitrogen-containing species.

### Example 2

Treatment of an aqueous bromide-containing solution derived from the synthesis of a pharmaceutical intermediate, having the characteristics below:

pH=6.3,

Bromides: 504 g/l,

Total nitrogen≦30 mg/l,

TOC=11.4 g/l.

A sample of this solution is subjected to a treatment not in accordance with the invention, which consists in performing a liquid/liquid extraction with CH₂Cl₂. Analysis by gas chromatography of the solvent after extraction reveals that very little of the organic compounds present have been removed.

Application of treatment a) according to the invention:

A sample of the crude (initial) aqueous bromide-containing solution is subjected to an acidification with H₂SO₄ until a pH equal to 3 is obtained.

The solution thus acidified is subjected to entrainment with water vapour.

The solution thus treated, diluted so as to bring the bromide concentration to 300 g/l, has the following characteristics:

pH=3,

TOC=6 g/l, as a reminder, Br⁻=300 g/l.

In this specific case, treatment a) in acidic medium alone does not allow the organic compounds to be removed sufficiently to achieve a TOC of not more than 2 g/l. Treatment d) is thus applied thereafter.

A sample of the above acidic solution is evaporated to dryness so as to obtain a solid residue (which has a yellow colour), which will be referred to hereinbelow as CRUDE SOLID, and which still has a TOC of 6 g/l relative to a solution of 300 g/l of bromides.

The CRUDE SOLID obtained above is subjected to washing with acetone:

30.2 g of the CRUDE SOLID are suspended in 40 ml of acetone and stirred for 30 minutes, followed by filtration of the acetone suspension.

The filtrate is discarded and the cake is subjected to a second wash with 40 ml of acetone under the above conditions.

After filtration, the cake obtained is dried in warm air at 40° C., and 28.3 g of dry NaBr are finally obtained, the TOC of which is still 2.1 g/l (relative to an aqueous solution of 300 g/l of Br⁻ in water).

The washing operation with acetone gives an aqueous bromide-containing solution with a TOC that is just about acceptable for oxidation via the chlorine method.

Treatment of the CRUDE SOLID with isopropanol under the same conditions described above produces an aqueous bromide-containing solution which, at 300 g/l of bromides, has a TOC of 1.6 g/l.

The product thus obtained allows the chlorine oxidation process to be applied in order to recover the elemental bromine.

### Example 3

Treatment of aqueous KBr solution obtained from the synthesis of a pharmaceutical intermediate, having the following characteristics:

pH=6.9,

TOC=21.5 g/l,

Total nitrogen: 3.3 g/l.

The liquid/liquid extraction treatment (as performed in Example 2) or vapour entrainment treatment according to the process of the invention did not allow the organics present in this solution to be removed.

Evaporation of this solution to dryness produces a crude solid, the characteristics of which (after dissolution to 300 g/l to determine the TOC) are as follows:

TOC=2.1 g/l,

Total nitrogen=3.5 g/l derived essentially from a quaternary ammonium salt.

The distillate obtained during the evaporation to dryness has a TOC of 1.3 g/l and a total nitrogen content of 43.3 mg/l.

Treatment According to d): Washing of the Crude Solid

1. Washing with acetone:

100 g of the crude solid obtained above are washed twice with 50 ml of acetone and then dried with warm air.

The acetone filtrate recovered contains about 0.46% by weight of bromides, whereas the dried cake makes it possible to obtain, after dissolution to 300 g/l of bromides, an aqueous KBr solution having the following characteristics:

TOC=0.68 g/l,

Total nitrogen=0.96 g/l.

This aqueous KBr solution cannot be subjected to a chlorine oxidation, since it has a total nitrogen content of greater than 50 mg/l (risk of formation of explosive NBr₃).

2. Washing with isopropanol:

100 g of crude solid are washed twice with 50 ml of isopropanol and then dried with warm air.

The isopropanol filtrate recovered contains about 1.6% by weight of bromides.

The dried cake makes it possible to obtain, after dissolution to 300 g/l of bromides, an aqueous KBr solution having the following characteristics:

TOC=142 mg/l,

Total nitrogen=20 mg/l.

This solution is thus able to be subjected to a chlorine oxidation in order to obtain elemental bromine.

What is claimed is:

1. Process for lowering the content of organic matter and of nitrogenous products contained in a bromide-containing effluent that is in the form of an aqueous bromide-containing solution or of a bromide-containing solid, comprising subjecting said bromide-containing effluent to one or more physicochemical treatments chosen from:
a) acidification of an aqueous bromide-containing solution or of a solution obtained by dissolution if the bromide-containing effluent is solid, followed by vapour entrainment of the light organic compounds;
b) basification of the solution obtained in a) or of the initial aqueous bromide-containing solution obtained by dissolution if the bromide-containing effluent is solid, followed by vapour entrainment of the light organoamine compounds and/or of NH₃;
c) vapour entrainment of light organic compounds from the aqueous solution obtained in a), or from the solution obtained in b), or from an initial bromide-containing solution obtained by dissolution if the effluent is solid, without modifying the pH;
d) washing a solid bromide-containing effluent to be treated or a solid derived from the evaporation of an aqueous bromide-containing solution resulting from one or more preceding treatment(s), with an organic solvent, filtration of the suspension obtained, and washing and drying of the cake obtained.

2. Process according to claim 1, comprising subjecting said bromide-containing effluent to one or more treatment(s) a), b), c) or d), in any order depending on the nature of the organic matter and nitrogenous products present to be removed and on the form of the bromide-containing effluent to be treated.

3. Process according to claim 2 comprising subjecting said bromide-containing effluent to one or more treatment(s) a), b), c), or d) in the order a), b), c), d).

4. Process according to claim 1, characterized in that the organic solvent used in treatment d) is chosen from solvents that dissolve a minimum amount of bromides and a maximum amount of organic matter and nitrogenous products.

5. Process according to claim 4, characterized in that the organic solvent used in treatment d) is chosen from acetonitrile, sec-butanol, isopropanol and acetone.

6. Process according to claim 5, characterized in that the organic solvent is isopropanol.

7. Process according to claim 1, characterized in that the acidification of the bromide-containing solution—treatment a)—is performed with an amount of a mineral acid that is sufficient to obtain a pH of not more than 3.

8. Process according to claim 1, characterized in that the basification of the bromide-containing solution—treatment b)—is performed with an amount of an alkaline agent that is sufficient to obtain a pH of at least 10.

9. Process according to claim 1, characterized in that the vapour entrainment of the acidic, basic or neutral bromide-containing solution is performed by injecting water or water vapour into said bromide-containing solution maintained at a temperature of at least 100° C., at atmospheric pressure.

10. Process of claim 1 wherein said treated aqueous bromide-containing solution with an alkaline bromide concentration of between 100 g/l and 500 g/l has a TOC of not more than 2,000 mg/l and a total nitrogen content of not more than 50 mg/l.

11. Process of claim 10 wherein said treated aqueous bromide-containing solution with an alkaline bromide concentration of about 300 g/l has a TOC of not more than 2,000 mg/l and a total nitrogen content of not more than 50 mg/l.

12. Use of the aqueous bromide-containing solution according to claim 10 for the upgrading of alkaline bromides to elemental bromine.
